(19) United States
(12) Patent Application Publication
(10) Pub. No.: US 2025/0201001 A1
(43) Pub. Date: Jun. 19, 2025

(54) THREE-DIMENSIONAL (3D) OBJECT DETECTION METHOD, APPARATUS, CONTROLLER, VEHICLE, AND MEDIUM

(71) Applicant: Robert Bosch GmbH, Stuttgart (DE)

(72) Inventors: Changhao Cheng, Suzhou (CN); Yanguang Bi, Suzhou (CN); Yazhe Tang, Suzhou (CN)

(21) Appl. No.: 18/972,896

(22) Filed: Dec. 7, 2024

(30) Foreign Application Priority Data
Dec. 13, 2023 (CN) 2023 1171 3066.0

(51) Int. Cl. G06V 20/64; G06V 10/26; G06V 10/82; G06V 20/56

(52) U.S. Cl. CPC G06V 20/64; G06V 10/26; G06V 10/82; G06V 20/56; G06V 2201/07

(57) ABSTRACT

The present disclosure relates to methods, apparatuses, controllers, vehicles, and media for three-dimensional (3D) object detection. The method includes obtaining a detection point cloud for a target 3D scene, wherein the detection point cloud comprises multiple detection points corresponding to multiple object points in the target 3D scene. The method further includes generating at least one shadow point based on offset operations on the multiple detection points. The method also includes detecting objects in the target 3D scene based on the multiple detection points and the at least one shadow point. Shadow points can be generated through offset operations based on the original detection points, thereby preventing or reducing information loss in 3D object detection and improving the accuracy of 3D object detection.

This application claims priority under 35 U.S.C. § 119 to patent application no. CN 2023 1171 3066.0, filed on Dec. 13, 2023 in China, the disclosure of which is incorporated herein by reference in its entirety

The examples of the present disclosure relate to the field of data processing, specifically to methods, apparatuses, controllers, vehicles, and media for three-dimensional 3D) object detection.

### BACKGROUND

With the development of smart devices, the demand for object detection in scenes is increasing, and in an increasing number of applications, it is necessary to detect objects in three-dimensional (3D) scenes (such as roads, office areas, or playgrounds). For example, during the autonomous or assisted driving of a vehicle, it is necessary to detect objects (such as people or other vehicles) in the 3D driving scene to determine the driving operations to be performed. For such applications, the accuracy of object detection may directly affect user safety, making the accuracy of object detection extremely important.

### SUMMARY

Embodiments of the present disclosure provide a method, apparatus, controller, vehicle, and medium for three-dimensional (3D) object detection.

According to a first aspect of the present disclosure, a method for 3D object detection is provided. The method comprises obtaining a detection point cloud for a target 3D scene, wherein the detection point cloud comprises multiple detection points corresponding to multiple object points in the target 3D scene. The method further comprises generating at least one shadow point based on offset operations on the multiple detection points. The method further comprises detecting objects in the target 3D scene based on the multiple detection points and the at least one shadow point.

According to a second aspect of the present disclosure, an apparatus for 3D object detection is provided. The apparatus comprises an obtaining unit, configured to obtain a detection point cloud for a target 3D scene, wherein the detection point cloud comprises multiple detection points corresponding to multiple object points in the target 3D scene. The apparatus further comprises a generating unit, configured to generate at least one shadow point based on offset operations on the multiple detection points. The apparatus further comprises a detecting unit, configured to detect objects in the target 3D scene based on the multiple detection points and the at least one shadow point.

According to a third aspect of the present disclosure, a controller is provided. The controller comprises at least one processor and a memory coupled to the at least one processor, with instructions stored thereon. When executed by the at least one processor, the instructions cause the controller to implement the method according to the first aspect of the present disclosure.

According to a fourth aspect of the present disclosure, a vehicle is provided. The vehicle comprises the controller according to the third aspect of the present disclosure.

In a fifth aspect of the present disclosure, a computer-readable storage medium is provided. The computer-readable storage medium stores computer-executable instructions, which, when executed by a processor, implement the method according to the first aspect of the present disclosure.

### BRIEF DESCRIPTION OF THE DRAWINGS

The exemplary examples of the present disclosure will be described in further detail in conjunction with accompanying drawings in order to further clarify the above-mentioned and other objectives, features and advantages of the present disclosure, wherein in the exemplary examples of the present disclosure, the same reference number typically represents the same parts.

FIG. 1 illustrates a schematic diagram of an example environment in which the apparatus and/or method according to examples of the present disclosure can be implemented.

FIG. 2 illustrates a flowchart of a method for three-dimensional (3D) object detection according to examples of the present disclosure.

FIG. 3 illustrates a flowchart of a process for generating shadow points according to examples of the present disclosure.

FIG. 4 illustrates a schematic diagram of an example of generating shadow points according to examples of the present disclosure.

FIG. 5 illustrates a schematic diagram of another example of generating shadow points according to examples of the present disclosure.

FIG. 6 illustrates a schematic diagram of an example of a projected two-dimensional (2D) pseudo-image according to examples of the present disclosure.

FIG. 7 illustrates a schematic diagram of a neural network model according to examples of the present disclosure.

FIG. 8 illustrates a schematic block diagram of an apparatus for 3D object detection according to examples of the present disclosure.

FIG. 9 illustrates a schematic block diagram of an example device suitable for implementing examples of the present disclosure.

In the various accompanying drawings, the same or corresponding numbers represent the same or corresponding portions.

### DETAILED DESCRIPTION

The examples of the present disclosure will be described in further detail below with reference to the accompanying drawings. Although certain examples of the present disclosure are shown in the accompanying drawings, it should be understood that the present disclosure may be implemented in various forms and should not be construed as being limited to the examples set forth herein, rather these examples are provided for a more thorough and complete understanding of the present disclosure. It should be understood that the accompanying drawings and examples of the present disclosure are for exemplary purposes only and are not intended to limit the scope of protection of the present disclosure.

In the description of the examples disclosed herein, the term “comprises” and similar terms should be understood as open-ended inclusion, meaning “including but not limited to”. The term “based on” should be understood as “at least partially based on”. The term “one embodiment” or “the embodiment” should be understood as “at least one embodiment”. The terms “first,” “second,” etc., can refer to different or the same objects. Other explicit and implicit definitions may be included below.

With the development of smart devices, there is an increasing demand for object detection in three-dimensional (3D) scenes. To facilitate 3D object detection, detection point clouds for 3D scenes are typically projected from a predetermined perspective into two-dimensional (2D) pseudo-images, allowing the use of 2D image detection methods to perform 3D object detection. Common projection methods, for example, can comprise Bird's Eye View (BEV, also known as “top-down view”) projection, Range View (RV) projection, and multi-view fusion projection.

During the projection process, the detection space corresponding to the 3D scene (where multiple detection points of the detection point cloud are distributed) is typically divided into multiple voxels, and 2D projection is performed on a voxel-by-voxel basis. Consequently, corresponding spatial information may be lost during projection, such as the loss of information in certain dimensions. For example, in the BEV projection method, only information from higher detection points in the vertical direction within the same voxel can be effectively mapped during the projection process, while information from lower detection points may be lost. For instance, a person in a 3D scene may only be projected as the outline of the head and shoulders, with side information being lost. In other words, the BEV projection method loses height information, and detection points compete in terms of height. Similarly, the RV projection method loses depth information. This loss of information may lead to inaccurate detection results in 3D object detection. To improve the accuracy of detection results, a multi-view fusion projection method can be used, which combines the above two methods. However, the multi-view fusion projection method requires a significant amount of computational resources, making it unsupportable by typical electronic devices and resulting in excessive costs.

To address at least the aforementioned and other potential issues, examples of the present disclosure provide a method for 3D object detection. The method comprises obtaining a detection point cloud for a target 3D scene, wherein the detection point cloud comprises multiple detection points for multiple object points in the target 3D scene. The method further comprises generating at least one shadow point based on offset operations on the multiple detection points. The method further comprises detecting objects in the target 3D scene based on the multiple detection points and the at least one shadow point. According to the method of the examples of the present disclosure, shadow points can be generated through offset operations based on the original detection points, thereby preventing or reducing information loss in 3D object detection and improving the accuracy of 3D object detection.

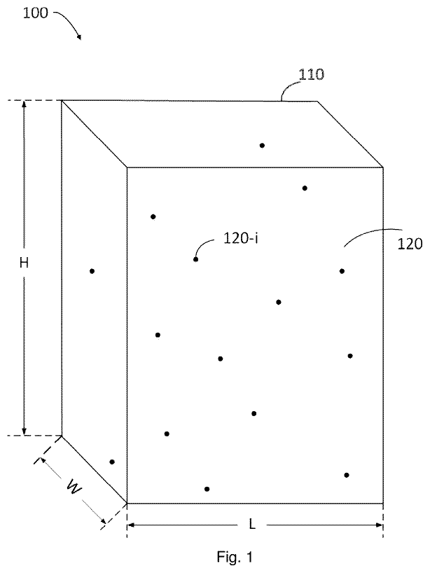

Below, examples of the present disclosure will be described in detail with reference to the accompanying drawings. FIG. 1 illustrates a schematic diagram of an example environment 100 in which the apparatus and/or method according to an embodiment of the present disclosure can be implemented. As shown in FIG. 1, the example environment 100 comprises a 3D detection space 110 corresponding to a target 3D scene. The 3D detection space 110 can be a virtual space representing the target 3D scene. The target 3D scene can be any scene, such as a road, office area, or amusement park. In some examples, the length, width, and height of the 3D detection space can be set according to the length, width, and height of the target 3D scene. For example, the length L, width W, and height H of the 3D detection space can be set to be the same as the length, width, and height of the target 3D scene, respectively.

The detection point cloud 120 for the target 3D scene can be distributed within the 3D detection space 110. In some examples, the detection point cloud 120 can be a LiDAR point cloud obtained by a LiDAR. For example, a LiDAR point cloud obtained by a LiDAR on a vehicle. The detection point cloud 120 can comprise multiple detection points for multiple object points in the target 3D scene. For example, the multiple object points can be points on people or vehicles in a road scene (e.g., numerous points on each pedestrian or numerous points on each vehicle). In FIG. 1, the detection points in the detection point cloud 120 are represented by solid dots, and one of the detection points 120-i (where i is an integer greater than or equal to 1) is labeled. In the following, detection point 120-i will be described as an example, but it should be understood that the description for detection point 120-i can apply to any other detection point. It should also be understood that the detection point cloud 120 can comprise more or fewer detection points than shown in FIG. 1 and can have a different distribution than that shown in FIG. 1.

After obtaining the detection point cloud 120 as shown in FIG. 1, according to an embodiment of the present disclosure, the detection point cloud 120 can be projected into a two-dimensional (2D) pseudo-image using a predetermined projection method without losing information of the corresponding dimensions (e.g., height information for a top-down projection method) or reducing the information loss of the corresponding dimensions. This can make object detection using the 2D pseudo-image more accurate. In the example below, a predetermined projection method of a top-down view (i.e., BEV) will be used as an example for further description.

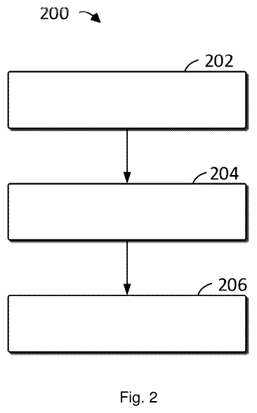

FIG. 2 illustrates a flowchart of a method 200 for 3D object detection according to an embodiment of the present disclosure. The method 200 can be performed by any controller or electronic device, or by a trained neural network model, or by a combination of a controller or electronic device and a trained neural network model. 1 As shown in FIG. 2, at block 202, a detection point cloud for the target 3D scene (e.g., the detection point cloud 120 shown in FIG. 1) is obtained. The detection point cloud 120 comprises multiple detection points for multiple object points in the target 3D scene. The target 3D scene can be any scene, such as a road, office area, or amusement park. The object points in the target 3D scene can be any object points, such as points on people, vehicles, or any other objects in the scene.

In some examples, the detection point cloud 120 can be a LIDAR point cloud obtained by a LIDAR (e.g., on a vehicle). In some examples, multiple detection points in the detection point cloud 120 correspond one-to-one with multiple object points. That is, for each object point, there is a detection point. In some examples, multiple detection points are distributed in a 3D detection space representing the target 3D scene (e.g., the 3D detection space 110 shown in FIG. 1). In some examples, the position of each detection point (e.g., the detection point 120-i shown in FIG. 1) in the 3D detection space 110 corresponds to the position of the corresponding object point in the target 3D scene.

At block 204, at least one shadow point is generated based on an offset operation of multiple detection points. In some examples, at least one shadow point can be generated by performing a horizontal offset operation on multiple detection points. This can replicate the information of the original detection point 120-i to another position in the 3D detection space, thereby retaining its specific dimension information (e.g., height) according to the degree of offset of the detection point (which will be further described in the example below).

At block 206, objects in the target 3D scene are detected based on multiple detection points and at least one shadow point. For example, a 2D pseudo-image can be generated by projecting the original multiple detection points and the generated at least one shadow point to detect objects in the target 3D scene. This allows for obtaining a 2D pseudo-image with more comprehensive information about the measured object through the specific dimensional information indicated by the shadow points, thereby enabling more accurate 3D object detection using this 2D pseudo-image. According to the method 200 of the examples of the present disclosure, shadow points can be generated through offset operations based on the original detection points, thereby preventing or reducing information loss in 3D object detection and improving the accuracy of 3D object detection.

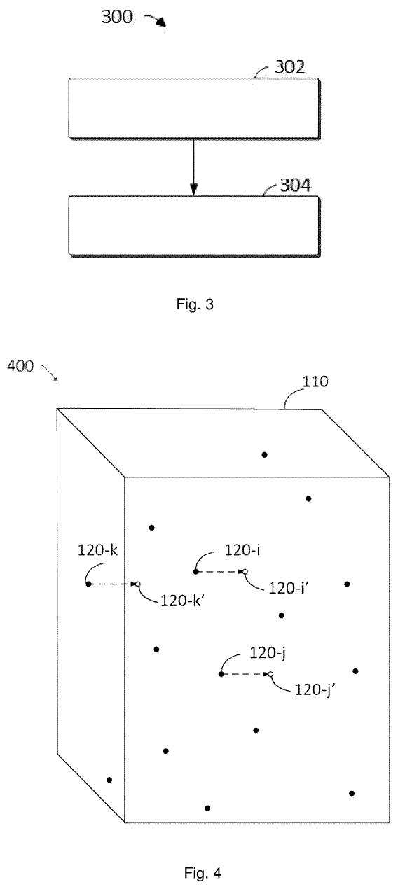

FIG. 3 illustrates a flowchart of a process 300 for generating shadow points according to examples of the present disclosure. The process of FIG. 3 can correspond to block 204 in FIG. 2. In some examples, each detection point 120-i in the detection point cloud obtained at block 202 of FIG. 2 can have detection point information, which can comprise: detection point position and detection point characteristics. In some examples, the detection point position can comprise: horizontal position and height. For example, the detection point position of each detection point 120-i can be represented by position coordinates (xi, yi, zi) in a Cartesian coordinate system. These position coordinates can represent the position of detection point 120-i in the 3D detection space 110, and accordingly, they can also represent the position of the corresponding object point in the target 3D space. In some examples, the detection point characteristics within the detection point information can indicate the characteristics of the corresponding object points. For example, the detection point characteristics can represent all other detection information (e.g., intensity of the detection signal, spectral distribution, etc.) aside from the detection point's position, which can be used to indicate the characteristics of the object points.

After obtaining multiple detection points with the aforementioned detection point information, in some examples, at block 302 of FIG. 3, at least one detection point among the multiple detection points can be selected as a target detection point. For instance, detection point 120-i can be chosen as one of the target detection points. At block 304, for each target detection point among at least one target detection point (for example, target detection point 120-i), an offset corresponding shadow point in the horizontal direction relative to the target detection point 120-i can be generated by offsetting the horizontal position of the target detection point based on the height of the target detection point. In some examples, the corresponding shadow point has shadow point information, which can comprise: the shadow point position and the detection point characteristics of target detection point 120-i. In some examples, the shadow point position can comprise: the offset horizontal position obtained via offsetting and the height of target detection point 120-i. In other words, the difference between the shadow point information of the generated corresponding shadow point and the detection point information of target detection point 120-i can only lie in the horizontal position. Furthermore, it should be understood that, as needed, additional different information can be added to the shadow point information and detection point information, such as flag information to distinguish the corresponding shadow point from the target detection point, which will be further described in the examples below.

FIG. 4 illustrates a schematic diagram 400 of an example of generating shadow points according to examples of the present disclosure. In FIG. 4, solid dots represent the original detection points (including the target detection points), hollow circles represent the shadow points, and dashed arrows indicate the offset in the horizontal direction. FIG. 4 shows three detection points 120-i, 120-j, and 120-k selected as target detection points, and illustrates the three corresponding shadow points 120-i′, 120-j′, and 120-k′ generated by horizontally offsetting these three detection points 120-i, 120-j, and 120-k. As can be seen from FIG. 4, the corresponding shadow points 120-i′, 120-j′, and 120-k′ are only horizontally offset relative to the original detection points (target detection points) 120-i, 120-j, and 120-k, while the height remains unchanged. In this embodiment, i, j, k can be mutually different integers greater than or equal to 1.

In some examples, the corresponding shadow point 120-i′ with position coordinates (xi, yi, zi) of the target detection point 120-i can be generated according to the following equations (1), (2), and (3) (it should be understood that this also applies to other target detection points) . . .

$${xi}^{′} = xi + σ \times zi \qquad ( 1 )$$

$${yi}^{′} = yi + σ \times zi \qquad ( 2 )$$

$${zi}^{′} = zi \qquad ( 3 )$$

In the above equations (1)-(3), σ is an offset constant, which can be set as needed or determined by a trained neural network model. xi′, yi′ and zi′ are the position coordinates (xi′, yi′, zi′) of the corresponding shadow point 120-i′. As can be seen from the above equations (1)-(3), the corresponding shadow point 120-i′ is only horizontally offset relative to the target detection point 120-i (i.e., in the (x, y) plane), while the height remains unchanged. Moreover, the degree of offset of the corresponding shadow sub-point 120-i′ in the horizontal direction is related to the height zi of the target detection point 120-i. Therefore, the height of the target detection point can be determined by the degree of offset. Thus, when projecting the detection point cloud into a 2D pseudo-image, the height information of the detection points can be retained, allowing for more accurate 3D object detection.

It should be understood that although only three detection points are shown as target detection points in FIG. 4, any number of detection points can be selected as target detection points as needed. For example, in some examples, to most comprehensively retain detection point information, all detection points in the detection point cloud 120 can be selected as target detection points. In other examples, for example, to balance computational resources and expected accuracy, at least one detection point in the detection point cloud 120 that meets predetermined conditions can be selected as a target detection point.

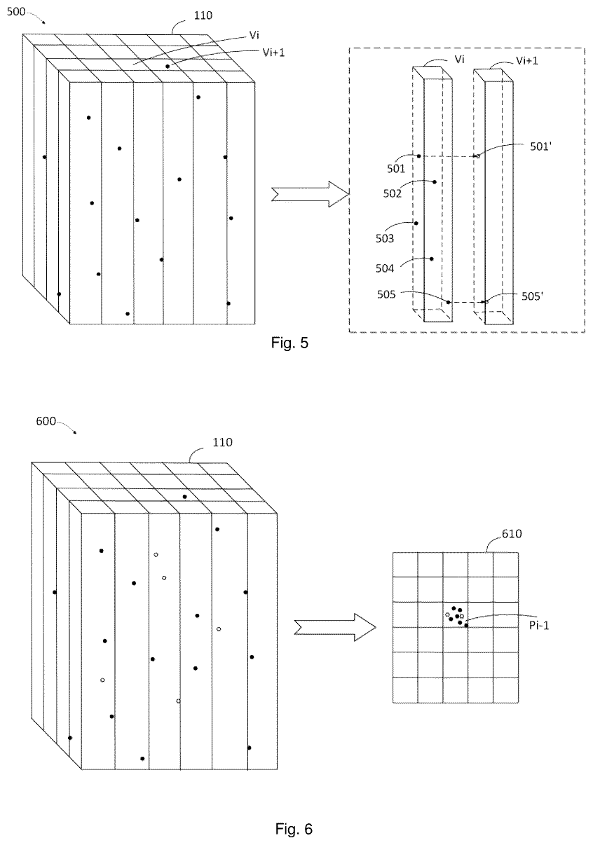

In some examples, the predetermined conditions can comprise the detection point position meeting predetermined position conditions. For example, for each detection point (e.g., detection point 120-i), it can be determined whether at least one of its position coordinates (xi, yi, zi) is greater than the corresponding threshold, and if so, the detection point 120-i can be determined as a target detection point. In other examples, the predetermined conditions can comprise points in a predetermined region of a 2D image corresponding to the target 3D scene. For example, while obtaining the detection point cloud 120 by the vehicle's LIDAR, a 2D image of the same target 3D scene can also be obtained by the vehicle's camera. Subsequently, any type of feature extraction can be performed on the 2D image to determine the predetermined region of interest, such as extracting the foreground, background, or any boundary, or any other region. Then, the detection points corresponding to the points in the predetermined region of interest can be used as the aforementioned target detection points. In yet other examples, the predetermined conditions can comprise the detection point type belonging to a predetermined type. Here, the type of detection point can be determined by in any manner. The following description, with reference to FIG. 5, illustrates an example of selecting target detection points based on the type of detection points, and subsequently generating corresponding shadow points.

FIG. 5 illustrates a schematic diagram 500 of another example of generating shadow points according to an embodiment of the present disclosure. In some examples, to perform the projection of the detection point cloud, the method 200 according to an embodiment of the present disclosure can further comprise: Dividing the 3D detection space 110 into at least one voxel, where each voxel can have the same shape and volume (for the top-down projection method). As shown in FIG. 5, the detection space 110 is divided into multiple cube-shaped voxels, with two adjacent voxels Vi and Vi+1 labeled in FIG. 5. In some examples, each detection point can be located in a corresponding voxel among the divided voxels. It should be understood that there can be voxels without detection points.

After dividing into at least one voxel, in some examples, the method 200 according to an embodiment of the present disclosure can further comprise: determining voxel information for each voxel of the at least one voxel based on at least one of: the position of the voxel in the 3D detection space, and the detection point information of the detection points within the voxel. In some examples, the voxel information can be determined by a trained neural network model and can indicate the overall characteristics of all detection points within the voxel.

After obtaining the voxel information for each voxel as described above, in some examples, the method 200 according to the present disclosure can further comprise determining the type of each detection point 120-i as follows: determining the type of detection point 120-i by performing semantic segmentation on the corresponding voxel based on the detection point information of detection point 120-i and the voxel information of the corresponding voxel where detection point 120-i is located. For example, if it is determined that detection point 120-i is of a predetermined type, the detection point can be selected as a target detection point, thereby generating a corresponding shadow point.

For instance, the voxel Vi shown in FIG. 5 is used as an example for illustration. Voxel Vi has five detection points 501, 502, 503, 504, and 505. Among these five detection points, two detection points 501 and 505 are determined to belong to predetermined types (both can belong to different predetermined types), and thus are selected as target detection points. Corresponding shadow points 501′ and 505′ are generated for these two target detection points 501 and 505, respectively. Here, to allow the shadow points to more effectively reflect information of specific dimensions (e.g., height), in some examples, the target detection points 501 and 505 and their corresponding shadow points 501′ and 505′ can be located in different voxels Vi and Vi+1, and the shadow point information can further comprise the voxel information of the voxel Vi where the target detection points 501 and 505 are located. It should be understood that, although FIG. 5 shows the corresponding shadow points 501′ and 505′ of target detection points 501 and 505 in voxel Vi being located in the same voxel Vi+1, it should be understood that the corresponding shadow points 501′ and 505′ of target detection points 501 and 505 in voxel Vi can be located in different voxels (e.g., adjacent or non-adjacent voxels).

After generating at least one shadow point as described above, 3D object detection can be performed based on the original multiple detection points and the generated at least one shadow point, i.e., executing block 206 of FIG. 2. In some examples, block 206 can comprise: projecting multiple detection points and at least one shadow point into a 2D pseudo-image based on the top-down projection method, for example, through at least one voxel divided as shown in FIG. 5. In some examples, the projection can allow the voxel information of each voxel in at least one voxel and the shadow point information of the shadow points located in the voxel to be mapped as pixel information of corresponding pixels in the 2D pseudo-image.

FIG. 6 illustrates a schematic diagram 600 of an example of a projected 2D pseudo-image according to an embodiment of the present disclosure. As shown in FIG. 6, the 3D detection space 110 is divided into multiple voxels, each voxel being a cube with the same shape and volume. Some voxels may not have detection points and shadow points. Other voxels may have detection points but no shadow points. Some voxels may only have shadow points derived from detection points in other voxels. In other voxels, there may be both detection points and shadow points. Regardless of the type of voxel, the voxel information of the voxel and the shadow point information of the shadow points (if present) can be mapped as pixel information of corresponding pixels Pi in the 2D pseudo-image 610. It should be understood that the pixel Pi of the pseudo-image 610 shown in FIG. 6 is for illustrative purposes only and is not intended to indicate the graphics in the actually mapped image.

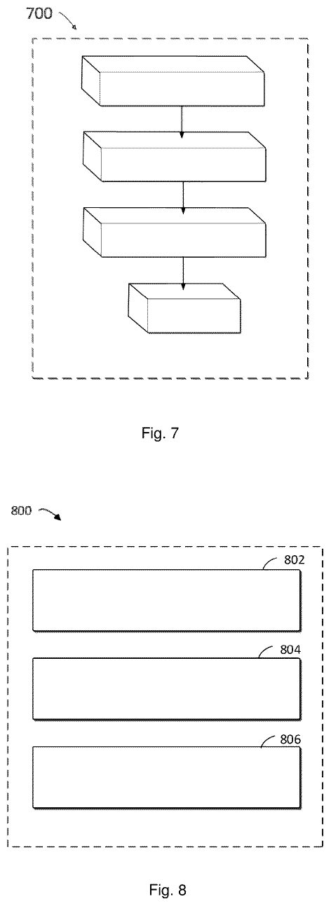

After obtaining the 2D pseudo-image 610 as described above, in some examples, block 206 can further comprise: Detecting objects in the target 3D scene based on the 2D pseudo-image 610. In some examples, the method 200 described above with reference to FIGS. 2-6 can be performed entirely or partially by a trained neural network model. FIG. 7 illustrates a schematic diagram 700 of a neural network model according to an embodiment of the present disclosure. In some examples, the neural network model 700 can be obtained based on any 3D object detection neural network model for performing 3D object detection. For example, a multilayer perceptron and max-pooling neural network model, such as a pillar-based 3D object detection neural network model.

When the method 200 according to the present disclosure is performed entirely by the neural network model 700, a trained neural network model 700 can be obtained by adding an algorithm for generating shadow points to a known 3D object detection neural network model and training it. During the training process of the neural network model 700, the input can be the detection points in the obtained detection point cloud, and the output can be the detected objects. Thus, the training data of the original 3D object detection neural network model can be used to train the neural network model 700 without creating new training data. This allows the method according to the present disclosure to be implemented easily and conveniently using known 3D object detection neural network models and their training data.

In addition, in the case where part of the method 200 according to the present disclosure is executed by the neural network model 700, it is only necessary to train a relatively simple predetermined neural network model for that part of the operation to obtain the trained neural network model 700. Furthermore, in some examples, during the execution of the aforementioned method 200 by the trained neural network model 700, flag information (e.g., a flag bit mask) can be added to the original detection points and the corresponding shadow points to distinguish between the two. For example, for the original detection points, the flag bit mask can be equal to one of “0” and “1”, while for the corresponding shadow points, the flag bit mask can be equal to the other of “0” and “1”. It should be understood that this is merely an example, and any other form of flag information can be used as needed. Additionally, in some examples, during the object detection process, the trained neural network model 700 can also choose whether to use part or all of the shadow point information, for example, depending on the required object detection accuracy and the expected detection efficiency.

FIG. 8 illustrates a schematic block diagram of an apparatus 800 for 3D object detection according to an embodiment of the present disclosure. As shown in FIG. 8, the apparatus 800 comprises an obtaining unit 802 configured to obtain a detection point cloud for a target 3D scene, where the detection point cloud comprises multiple detection points for multiple object points in the target 3D scene. The apparatus 800 further comprises a generating unit 804 configured to generate at least one shadow point based on an offset operation on the multiple detection points. The apparatus 800 further comprises a detecting unit 806 configured to detect objects in the target 3D scene based on the multiple detection points and at least one shadow point. In some examples, the apparatus 800 can be a trained neural network model.

In some examples, the detection point cloud can be a LIDAR point cloud obtained by LIDAR. In some examples, the multiple detection points can correspond one-to-one with multiple object points. In some examples, the multiple detection points can be distributed in a 3D detection space representing the target 3D scene. In some examples, the position of each detection point in the 3D detection space can correspond to the position of the corresponding object point in the target 3D scene. In some examples, the detection points can have detection point information, which can comprise: detection point position and detection point characteristics. In some examples, the detection point position can comprise: horizontal position and height. In some examples, the detection point characteristics can indicate the characteristics of the corresponding object point.

In some examples, the generating unit 804 can be configured to select at least one detection point from the multiple detection points as a target detection point. In some examples, the generating unit 804 can be configured to select all detection points from the multiple detection points as target detection points. In some examples, the generating unit 804 can be configured to select at least one detection point from the multiple detection points that meets predetermined conditions as a target detection point. In some examples, the predetermined conditions can comprise the detection point position meeting predetermined position conditions. In yet other examples, the predetermined conditions can comprise the detection point type belonging to a predetermined type. In some examples, the predetermined conditions can comprise points in a predetermined region of a 2D image corresponding to the target 3D scene.

In some examples, the generating unit 804 can also be configured to generate a corresponding shadow point offset in the horizontal direction relative to the target detection point by offsetting the horizontal position of the target detection point based on the height of the target detection point for each target detection point in at least one target detection point. In some examples, the corresponding shadow point can have shadow point information, which can comprise: the shadow point position and the detection point characteristics of the target detection point. In some examples, the shadow point position can comprise: the offset horizontal position obtained via the offset and the height of the target detection point.

In some examples, the apparatus 800 can further comprise a voxel unit, which can be configured to divide the 3D detection space into at least one voxel, with each voxel having the same shape and volume. In some examples, the voxel unit can also be configured to determine voxel information for each voxel in at least one voxel based on at least one of the following: the position of the voxel in the 3D detection space and the detection point information of all detection points within the voxel. In some examples, the apparatus 800 can further comprise a type determination unit configured to determine the type of each detection point as follows: by performing semantic segmentation on the corresponding voxel based on the detection point information of the detection point and the voxel information of the voxel in which the detection point is located, the type of the detection point is determined. In some examples, each detection point can be located in a corresponding voxel within at least one voxel. In some examples, the target detection point can be located in a different voxel than the corresponding shadow point. In some examples, the shadow point information can further comprise the voxel information of the voxel in which the target detection point is located.

In some examples, the detection unit 806 can be configured to project multiple detection points and at least one shadow point into a 2D pseudo-image based on a top-down projection method through at least one voxel. In some examples, the projection can allow the voxel information of each voxel in at least one voxel and the shadow point information of the shadow points located in the voxel to be mapped as pixel information of corresponding pixels in the 2D pseudo-image. In some examples, the detecting unit 806 can also be configured to detect objects in the target 3D scene based on the 2D pseudo-image.

According to the apparatus 800 of the examples of the present disclosure, shadow points can be generated through offset operations based on the original detection points, thereby preventing or reducing information loss in 3D object detection and improving the accuracy of 3D object detection.

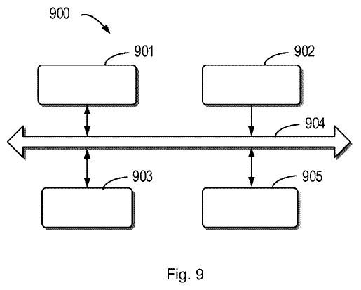

FIG. 9 shows a schematic block diagram of an exemplary device 900 suitable for implementing the examples of the present disclosure. The above-mentioned controller can be implemented using the device 900. As shown, the device 900 comprises a processor 901, which can execute various appropriate actions and processes according to computer program instructions stored in a read-only memory (ROM) 902 and loaded into a random access memory (RAM) 903. Various programs and data required for the operation of the device 900 can also be stored in the RAM 903. The processor 901, ROM 902, and RAM 903 are connected to each other via a bus 904. An input/output (I/O) interface 905 is also connected to the bus 904.

The various processes and procedures described above, such as method 200 and process 300, can be executed by processor 901. For example, in some examples, method 200 and process 300 can be implemented as a computer software program that is tangibly embodied in a machine-readable medium. In some examples, portions or all of the computer program can be loaded and/or installed onto device 900 via ROM 902. When the computer program is loaded into RAM 903 and executed by processor 901, one or more actions of method 200 and process 300 described above can be performed.

The present disclosure can be a method, apparatus, system, and/or computer program product. The computer program product can comprise a computer-readable storage medium having computer-readable program instructions stored thereon for executing various aspects of the present disclosure.

The computer-readable storage medium can be a tangible device that can retain and store instructions used by an instruction execution device. The computer-readable storage medium can be, for example, but not limited to, an electronic storage device, magnetic storage device, optical storage device, electromagnetic storage device, semiconductor storage device, or any suitable combination of the foregoing. More specific examples (a non-exhaustive list) of the computer-readable storage medium comprise: portable computer disks, hard disks, random access memory (RAM), read-only memory (ROM), erasable programmable read-only memory (EPROM or Flash memory), static random access memory (SRAM), portable compact disc read-only memory (CD-ROM), digital versatile disks (DVD), memory sticks, floppy disks, mechanical encoding devices, such as punch cards or grooves with raised structures, and any suitable combination of the foregoing. The computer-readable storage medium as used herein is not to be interpreted as transitory signals per se, such as radio waves or other freely propagating electromagnetic waves, electromagnetic waves propagating through waveguides or other transmission media (e.g., light pulses through a fiber optic cable), or electrical signals transmitted through wires.

The computer-readable program instructions described herein can be downloaded to respective computing/processing devices from a computer-readable storage medium or to an external computer or external storage device via a network, for example, the Internet, a local area network, a wide area network, and/or a wireless network. The network can comprise copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

The computer program instructions for performing operations of the present disclosure can be assembly instructions, instruction set architecture (ISA) instructions, machine instructions, machine-dependent instructions, microcode, firmware instructions, state-setting data, or source code or object code written in any combination of one or more programming languages, wherein the programming languages comprise object-oriented programming languages—such as Smalltalk, C++, etc.—and conventional procedural programming languages—such as the “C” programming language or similar programming languages. The computer-readable program instructions can execute entirely on the user's computer, partly on the user's computer, as a standalone software package, partly on the user's computer and partly on a remote computer, or entirely on the remote computer or server. In the case of remote computers, the remote computer can be connected to the user's computer through any type of network—such as a local area network (LAN) or a wide area network (WAN)—or can be connected to an external computer (for example, through the Internet using an Internet Service Provider). In some examples, electronic circuits, such as programmable logic circuits, field-programmable gate arrays (FPGA), or programmable logic arrays (PLA), can be personalized by utilizing state information of the computer-readable program instructions, which can execute the computer-readable program instructions to implement various aspects of the present disclosure.

What is claimed is:

1. A method for three-dimensional (3D) object detection, comprising:
obtaining a detection point cloud for a target 3D scene, wherein the detection point cloud comprises multiple detection points corresponding to multiple object points in the target 3D scene;
generating at least one shadow point based on offset operations on the multiple detection points; and
detecting objects in the target 3D scene based on the multiple detection points and the at least one shadow point.

2. The method according to claim 1, wherein:
the multiple detection points correspond one-to-one with the multiple object points,
the multiple detection points are distributed in a 3D detection space representing the target 3D scene, and
the position of each detection point in the 3D detection space corresponds to the position of the corresponding object point in the target 3D scene.

3. The method according to claim 2, wherein:
the detection points have detection point information, which comprises detection point position and detection point characteristics,
the detection point position comprises: horizontal position and height, and
the detection point characteristics indicate the characteristics of the corresponding object point.

4. The method according to claim 3, wherein generating at least one shadow point based on the multiple detection points comprises:
selecting at least one detection point from the multiple detection points as a target detection point; and
for each target detection point of the at least one detection point, generating an offset corresponding shadow point in the horizontal direction relative to the target detection point by offsetting the horizontal position of the target detection point based on the height of the target detection point,
wherein the corresponding shadow point has shadow point information, which comprises: shadow point position, and detection point characteristics of the target detection point, and
wherein the shadow point position comprises: the offset horizontal position obtained via the offset operation, and the height of the target detection point.

5. The method according to claim 4, wherein selecting at least one detection point from the multiple detection points as a target detection point comprises:
selecting all detection points from the multiple detection points as target detection points, or
selecting at least one detection point from the multiple detection points that meets predetermined conditions as the target detection point.

6. The method according to claim 5, wherein the predetermined conditions comprise at least one of:
detection point position meeting a predetermined position condition,
detection point type belonging to a predetermined type, and
detection point corresponding to a point in a predetermined region of a two-dimensional (2D) image of the target 3D scene.

7. The method according to claim 6, further comprising:
dividing the 3D detection space into at least one voxel, which has the same shape and volume; and
determining voxel information for each voxel of the at least one voxel based on at least one of: the position of the voxel in the 3D detection space and the detection point information of all detection points within the voxel.

8. The method according to claim 7, wherein each detection point is located in a corresponding voxel of the at least one voxel, and
wherein the target detection point and the corresponding shadow point are located in different voxels, and the shadow point information further comprises voxel information of the voxel in which the target detection point is located.

9. The method according to claim 8, wherein detecting objects in the target 3D scene based on the multiple detection points and the at least one shadow point comprises:
projecting the multiple detection points and the at least one shadow point as a 2D pseudo-image through the at least one voxel based on a top-down projection method; and
detecting objects in the target 3D scene based on the 2D pseudo-image,
wherein the projection maps voxel information of each voxel in the at least one voxel and shadow point information of shadow points located in the voxel as pixel information of corresponding pixels in the 2D pseudo-image.

10. The method according to claim 7, further comprising determining the type of each detection point as follows:
determining the type of the detection point by semantically segmenting the corresponding voxel based on the detection point information of the detection point and the voxel information of the voxel in which the detection point is located.

11. The method according to claim 1, wherein:
the detection point cloud is a LIDAR point cloud obtained by LIDAR, and
the method is performed by a trained neural network model.

12. An apparatus for three-dimensional (3D) object detection, comprising:
an obtaining unit, configured to obtain a detection point cloud for a target 3D scene, with the detection point cloud comprising multiple detection points corresponding to multiple object points in the target 3D scene;
a generating unit, configured to generate at least one shadow point based on offset operations on the multiple detection points; and
a detecting unit, configured to detect objects in the target 3D scene based on the multiple detection points and the at least one shadow point.

13. A controller, comprising:
at least one processor; and
a memory, coupled to the at least one processor and having instructions stored thereon, wherein the instructions, when executed by the at least one processor, cause the controller to perform the method according to claim 1.

14. A vehicle comprising the controller according to claim 13.

15. A computer-readable storage medium having computer-executable instructions stored thereon, wherein the computer-executable instructions are executed by a processor to implement the method according to claim 1.
